(19) United States
(12) Patent Application Publication
(10) Pub. No.: US 2014/0095133 A1
(43) Pub. Date: Apr. 3, 2014

(54) SYSTEMS AND METHODS FOR MANAGING MECHANICAL SYSTEMS AND COMPONENTS

(71) Applicant: GENERAL ELECTRIC COMPANY, Schenectady, NY (US)

(72) Inventors: Francisco Bautista Silva, Queretaro (MX); Luis Alberto Reyes, Queretaro (MX); Noe Aguirre Lira, Queretaro (MX); Walther Diener, Queretaro (MX); Monica Pelayo Granados, Queretaro (MX); Victor Garcia, Queretaro (MX); Oscar Ulises Almeida, Queretaro (MX); Oscar Saavedra, Cuajimalpa de Morelos (MX)

(73) Assignee: General Electric Company, Schenectady, NY (US)

(21) Appl. No.: 13/631,698

(22) Filed: Sep. 28, 2012

(51) Int. Cl. G06G 7/64

(52) U.S. Cl. 703/7

(57) ABSTRACT

A system includes an interface configured to receive one or more images from an inspection of a component of a mechanical system. Each of the one or more images includes corresponding annotations that at least define one or more dimensions of the component or damages observed in the component. The system also includes a processor configured to construct a degradation model for the component based, at least in part, on the one or more images and their corresponding annotations received by the interface. The processor is further configured to determine one or more maintenance recommendations for the component based, at least in part, on the degradation model constructed for the component.

### BACKGROUND

The subject matter disclosed herein relates to tracking and modeling degradation of mechanical components.

Mechanical systems, such as engines and turbines, generally degrade as the components of the system wear and incur damage as a result of usage. Accordingly, in order to maintain such mechanical systems, maintenance may be performed according to a regular maintenance schedule to ensure that the system is able to properly function. However, performing maintenance based solely on a schedule may not be efficient since, based on the schedule, unnecessary maintenance may be performed on one system while another system having issues may be neglected. Alternatively, maintenance may be performed based on the condition of the mechanical system (i.e., condition-based maintenance). For condition-based maintenance (CBM), a mechanical system may generally be maintained based on information gathered during inspections of the mechanical system.

However, without significant experience and/or expertise with a particular component or system, it may be difficult for an inspector to ascertain the degradation of the component or system. Furthermore, it may be difficult across a myriad of different systems, components, inspectors, and locations, to manage the data acquired during inspections in order to properly maintain the various mechanical systems. Accordingly, it may be advantageous have a system that manages this inspection and maintenance data such that accurate recommendations regarding the maintenance of the various components may be made. Further, it may be advantageous to have a system that allows the generation of reports to compare the number and type of events experienced by the various pieces of the equipment deployed in the fleet.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In an embodiment, a system includes an interface configured to receive one or more images from an inspection of a component of a mechanical system. Each of the one or more images includes corresponding annotations that at least define one or more dimensions of the component. The system also includes a processor configured to construct a degradation model for the component based, at least in part, on the one or more images and their corresponding annotations received by the interface. The processor is further configured to determine one or more maintenance recommendations for the component based, at least in part, on the degradation model constructed for the component.

In another embodiment, a method includes receiving and storing in a memory of an electronic device one or more event details for a part event. The part event includes an inspection or maintenance of a part of a mechanical system. The method also includes receiving and storing in the memory of the electronic device one or more event images of the part event. The method also includes constructing, via a processor of the electronic device, a degradation model for the part based, at least in part, on the one or more event details and the one or more event images. The method further includes determining, via the processor of the electronic device, maintenance recommendations for the part based, at least in part, on the degradation model for the part.

In another embodiment, one or more tangible, non-transitory, computer-readable media store instructions executable by a processor of an electronic device. These instructions include instructions to receive a part identifier for a part of a mechanical system. The instructions also include instructions to determine information for the part and other substantially similar parts based on the received part identifier. The instructions also include instructions to receive one or more annotated inspection images for the part, in which one or more annotated inspection images indicate one or more dimensions of the part. The instructions further include instructions to construct a degradation model for the part based, at least in part, on the one or more annotated inspection images and the information for the part and other substantially similar parts. The instructions additionally include instructions to provide maintenance recommendations for the part based, at least in part, on the degradation model for the part and defined operational limits of the part.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic illustrating an embodiment of a hardware management system;

FIG. 2 is a schematic illustrating components of the hardware management system of FIG. 1;

FIG. 3 is a flow diagram illustrating an embodiment of a process for adding event data to the database for a mechanical system or part;

FIG. 4 is an embodiment of a data table of part information presented to a user after searching with a particular part identifier, in accordance with aspects of the present technique;

FIG. 5 is a simulated screenshot of an embodiment of a user interface for receiving event details for the part of FIG. 3;

FIG. 6 is a simulated screenshot of an embodiment of a user interface for receiving images for a part event of FIG. 5;

FIG. 7 is a flow diagram illustrating an embodiment of a process for quantifying part degradation and determining maintenance recommendations for the part event of FIG. 5;

FIG. 8 is a simulated screenshot of an embodiment of a user interface for receiving image annotations for an image corresponding to the part event of FIG. 5;

FIG. 9 is an embodiment of a graph illustrating the degradation trends of the part of FIG. 2 over a number of operational hours for the part;

FIG. 10 is an embodiment of a graph illustrating the predicted unreliability of the part of FIG. 2 versus the number operational hours of the part;

FIG. 11 is a flow diagram illustrating an embodiment of a process for generating an event report;

FIG. 12 is a simulated screenshot of an embodiment of a user interface for receiving a plurality of inputs to generate the event report of FIG. 11; and

FIG. 13 is an embodiment of the generated event report of FIG. 11.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

As mentioned above, condition-based maintenance (CBM) of mechanical systems (e.g., engines, turbines, or similar mechanical systems) generally involves the regular inspection of the system in order to evaluate the condition of the various components (e.g., blades, manifolds, valves, etc.) of the system. Furthermore, it may be desirable to maintain a fleet of similar mechanical systems across a number of different locations. With each mechanical system being inspected at regular intervals, this may result in a large quantity of maintenance and inspection data overall. Thus, due to the large volume of data accumulated, it may be difficult to obtain actionable intelligence to maintain the various mechanical systems in the fleet across the various locations. Additionally, it may be difficult to combine the expertise of an inspector at one location with inspection data obtained from a mechanical system operating at a different location.

Accordingly, present embodiments are directed towards systems and methods for managing event data (e.g., including inspection and maintenance data) for a number (e.g., a fleet) of mechanical systems that may be distributed across a number of different locations. In this manner, the presently disclosed hardware management system may provide recommendations for maintaining each of the mechanical systems in the fleet. In particular, present embodiments enable the users to construct degradation models for inspected components that are based on inspection and maintenance data accumulated from the entire fleet of mechanical systems. By efficiently managing inspection and maintenance data fleet-wide, the presently disclosed hardware management system may generally be able to provide maintenance recommendations without requiring expert input. However, certain embodiments may still allow for expert validation to ensure that maintenance recommendations are accurate. Additionally, the presently disclosed hardware management system may allow for an assessment of maintenance trends throughout the fleet (e.g., which mechanical systems and/or parts tend to need more maintenance, what part of the year mechanical systems and/or parts tend to fail, and so forth).

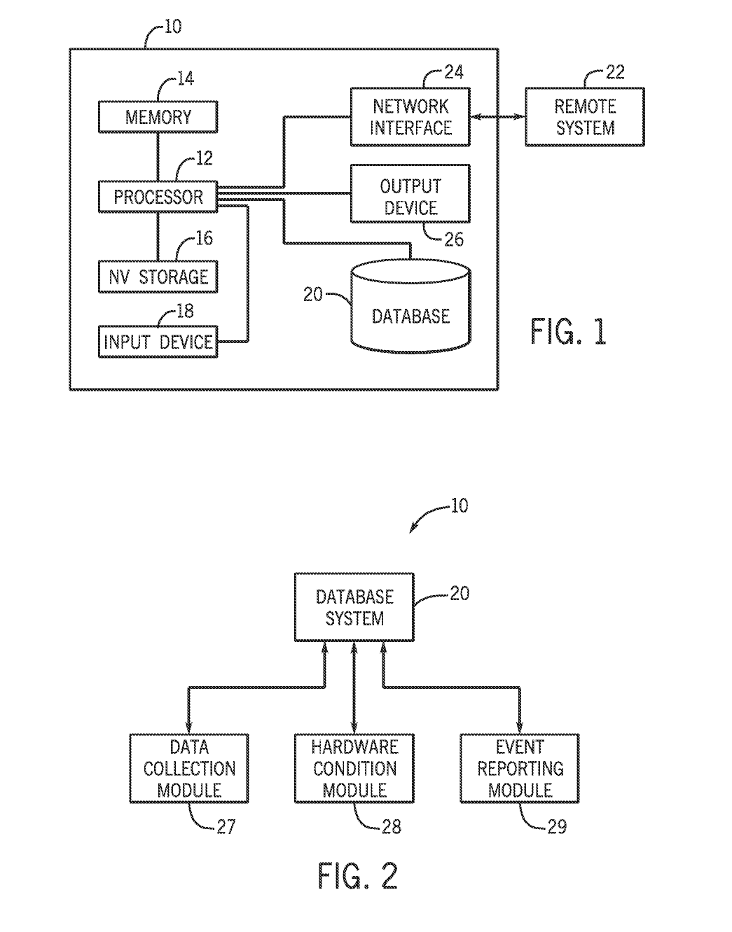

With the foregoing in mind, FIG. 1 illustrates an embodiment of a hardware management system 10. As set forth in detail below, the hardware management system 10 may generally manage the collection, analysis, and reporting of data associated with one or more mechanical systems in a fleet. Accordingly, the hardware management system 10 includes a processor 12 that may generally control the operation of the system 10 through the execution of instructions stored in memory 14 (e.g., random access memory (RAM)) and/or non-volatile (NV) storage 16 (e.g., a hard drive, flash drive, solid-state disk, or other suitable storage device). Additionally, the illustrated hardware management system 10 includes at least one input device 18 (e.g., a keyboard, mouse, scanner, digital camera, touchpad, touchscreen, or other suitable input device) to allow a user to provide data (e.g., textual data, image data, etc.) and/or instructions to the system 10. For example, as set forth below, a user may utilize such an input device 18 to data (e.g., identifiers, dates, notes, images, or similar data) into the system 10 regarding the inspection and/or maintenance of a particular component of a mechanical system (e.g., a combustor of a gas turbine).

Furthermore, the hardware management system 10 may include a database system 20 configured to store the inspection and maintenance data for the various components of the fleet. In certain embodiments, the database system 20 may be stored within a portion of the memory 14 and/or in NV storage 16. Furthermore, in certain embodiments, the hardware management system 10 may, additionally or alternatively, store the inspected inspection and maintenance data for the various components of the fleet in a database located on one or more remote systems 22 (e.g., a computer or mobile computing device located with the equipment at a certain remote location). Accordingly, the illustrated hardware management system 10 includes a network interface 24 configured to facilitate communication of data between the hardware management system 10 and remote systems 22. For example, in certain embodiments, the hardware management system 10 may, additionally or alternatively, receive event data (e.g., inspection and maintenance data) for certain mechanical systems and/or components of the fleet from a remote system 22 via the network interface 24. Additionally, the network interface 24 may be used to receive instructions (e.g., software updates, firmware upgrades, application updates, program updates, or other suitable instruction updates or upgrades) to update and/or replace the instruction stored in memory 14 to control the operation of the system 10. That is, the network interface 24 may generally allow the system 10 to be installed, updated, and maintained via a remote system 22 (e.g., an application or update server).

Additionally, the illustrated hardware management system 10 includes at least one output device 26 (e.g., a monitor, flat-panel display, printer, or other suitable output device) which may be used to present information (e.g., display graphs, output maintenance recommendations, or present similar information) to a user of the system 10. For example, the output device 26 may be used to present a user with a degradation curve for a part in a mechanical system, present recommendations to the user with respect to the maintenance of the part, present event reports for the part, and so forth. Furthermore, in certain embodiments, the network interface 24 may additionally be used to provide output (e.g., degradation curves, maintenance recommendations for mechanical systems or parts, event reports, etc.) to remote users of the system 10 that may access and/or use the system 10 from a remote system 22.

As mentioned, the hardware management system 10 may generally manage the collection, analysis, and reporting of data associated with one or more mechanical systems and parts in a fleet. FIG. 2 illustrates a number of components that may be present within an embodiment of the presently disclosed hardware management system 10. That is, FIG. 2 illustrates a number of modules (e.g., collections of instructions or software) that each generally provide a portion of the functionality of the hardware management system 10. For example, the hardware management system 10 illustrated in FIG. 2 includes three modules, namely a data collection module 27, a hardware condition module 28, and an event reporting module 29, which may all be stored in memory 14 and/or NV storage 16 and executed by the processor 12 of the hardware management system 10 illustrated in FIG. 1. Additionally, it should be appreciated that since users of the hardware management system 10 may include customers (e.g., purchasers of equipment and/or service), equipment manufacturers, and/or equipment maintenance providers, and the like, the hardware management system 10 may provide a standard channel of communication between all parties to exchange information pertaining to the maintenance of the fleet of mechanical systems.

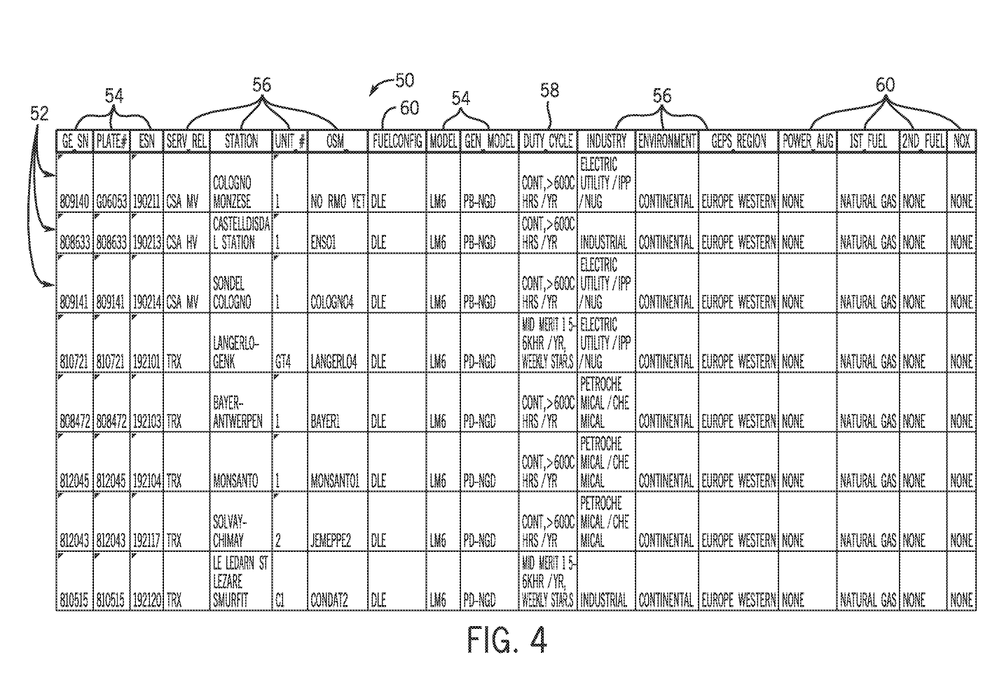

The data collection module 27 illustrated in FIG. 2, may generally handle receiving, storing, accessing, and/or modifying hardware event data (e.g., event data for inspections and/or maintenance) for the mechanical systems in the fleet. As such, when executed by the processor 12, the data collection module 27 provides a plurality of user interfaces (e.g., the user interfaces set forth below with respect to FIGS. 4-6) to enable local and remote users of the hardware management system 10 to enter, access, and modify data pertaining to events (e.g., trips, failures, warnings, inspections, maintenance, and so forth) experienced by components and/or mechanical systems in the fleet. In certain embodiments, these user interfaces may be presented locally (e.g., using output device 26) or on a remote device 22 (e.g., via the network interface 24).

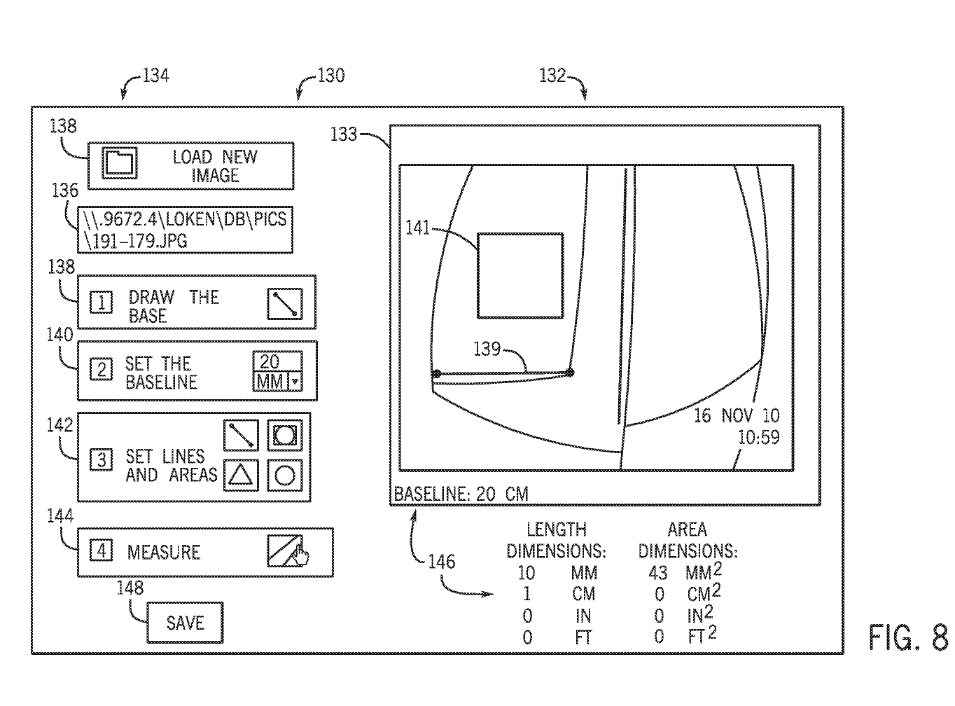

The hardware condition module 28 illustrated in FIG. 2 may generally enable the construction of one or more degradation models for mechanical systems and/or parts in the fleet. As set forth below with respect to FIG. 8, the hardware condition module 28, when executed by the processor 12, provides a number of user interfaces, for example, to enable the analysis of hardware inspection data (e.g., inspection images received by the data collection module 27). Further, the hardware condition module 28 enables the creation of degradation models for the various mechanical systems and/or parts (e.g., combustion engines and/or gas turbine systems) based, at least in part, on inspection and/or maintenance data for the various components (e.g., engines components and/or gas turbine components), as well as data relating to the performance of similar components in other mechanical systems (e.g., disposed at other locations). Additionally, as set forth for the data collection module 27 above, in certain embodiments, the hardware condition module 28 may serve local users (e.g., using input device 18 and output device 26) and/or remote users (e.g., via remote system 22 and network interface 24).

The event reporting module 29, also illustrated in FIG. 2, may generally enable the generation of event reports based, at least in part, on the hardware event data (e.g., collected by the data collection module 27). In addition to generating event reports themselves, the event reporting module 29, when executed by the processor 12, provides a number of user interfaces to receive selections from a user for the generation of these event reports. For example, the user interfaces may allow the user to set the parameters (e.g., part, type of event, time window, and so forth) of the event report. Further, the event report may include event rates (e.g., as a rolling average) for particular parts and/or engines in the fleet. Additionally, as set forth for the data collection module 27 and the hardware condition module 28 above, in certain embodiments, the event reporting module 29 may serve local users (e.g., using input device 18 and output device 26) and/or remote users (e.g., via remote system 22 and network interface 24).

For the embodiment illustrated in FIG. 2, all three modules (e.g., modules 27, 28, and 29) utilize the database system 20 for the storage and retrieval of data relating to the one or more mechanical systems in the fleet. For example, the data collection module 27 may generally utilize the database system 20 as a data repository to access and store the hardware event data, based on inputs received by the hardware management system 10. Further, the hardware condition module 28 may use the database system 20 to access hardware event data, such as inspection and/or maintenance data, and may also store generated degradation models (e.g., for mechanical systems and/or parts in the fleet) in the database system 20 as well. Additionally, the event reporting module 29 may generally use the database system 20 to access and store the hardware event data (e.g., hardware event data collected by the data collection module 27), and, may further store generated reports in the database system 20 as well. Accordingly, all three modules (e.g., modules 27, 28, and 29) are communicatively coupled to a common data source such that the modules may be free to exchange information in a common data pool.

Accordingly, the database system 20 illustrated in FIG. 2 may be capable of storing many different types of data (e.g., textual data, chart data, picture data, and so forth) pertaining to the fleet of mechanical systems and parts. In certain embodiments, the database system 20 may be implemented using a commercial database system (e.g., a suitable standard query language (SQL) database). Further, the information stored by the database system 20 may be collected, accessed, and/or modified by the modules 27, 28, and 29. Examples of data stored by the database system 20 include hours of operation, number of cycles, number of starts/stops, and so forth, for various mechanical systems and/or parts in the fleet. Additionally, the data stored by the database system 20 may also include event details (e.g., type of the event, cause of the event, time of the event, location of the event, downtime, and so forth) for various types of events (e.g., trips, failures, warnings, sections, maintenance, and so forth) experienced by the mechanical systems and/or components.

It should be appreciated that one aspect of the illustrated database system 20 is data validation. For example, as set forth below, the data collection module 27 may receive data (e.g., hours of operation, time since new (TSN), time since last repair (TSLR), time since last overhaul (TSLOH), or similar data) related to one or more mechanical systems in the fleet. However, under certain circumstances, one or more values entered by a particular user or extracted from a particular maintenance report may not be correctly provided to the data collection module 27 and/or database system 20. When this happens, the database system 20 may catch the mistake using one or more data validation steps. For example, in certain embodiments, the database system 20 may determine that the value entered by the user is incorrect by comparing the entered value to one or more limit values (e.g., 0 and 100,000, or other suitable limit values) that define a reasonable range for the parameter of the mechanical system and/or component. Further, in certain embodiments, the database system 20 may compare the questionable value to other data stored for the particular mechanical system or component (e.g., hours of operation values entered for previous or later time periods, an average hours of operation value for a time period, an estimated hours of operation based on a trend over a time period) in order to validate the supplied data. Additionally, in certain embodiments, the database system 20 may enable automatic communication (e.g., automatic email messages, automatic internal messaging, or other suitable communication) to one or more users of the hardware management system 10 (e.g., customers, hardware experts, hardware operators, hardware maintainers, etc.) to inform the users when a particular piece of data is determined to be invalid or questionable such that the users may manually validate and/or correct the data in question (e.g., expert or manual validation).

As mentioned, the hardware management system 10 may generally provide a platform, for example, for storing and accessing inspection and maintenance data for the fleet of mechanical systems, constructing degradation models for components of these mechanical systems, and making recommendations for the maintenance of these mechanical systems. Accordingly, the hardware management system 10 may be configured to receive (e.g., via input device 18 and/or network interface 24) and store (e.g., in database system 20) event information for the various mechanical systems and parts of the fleet. For example, as set forth below, the data collection module 27 of the hardware management system 10 may gather information from the inspection and/or maintenance of mechanical systems and parts (e.g., a combustor of the gas turbine).

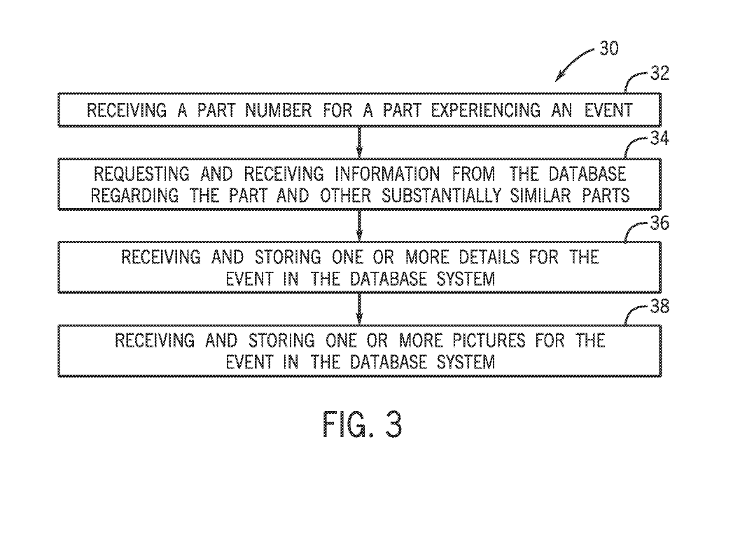

Accordingly, FIG. 3 illustrates an embodiment of a process 30 whereby the data collection module 27 may collect event data pertaining to a mechanical system and/or part. The illustrated process 30 begins with the hardware management system 10 receiving (block 32) a part identifier (e.g., a part number) for a particular component or part of a mechanical system experiencing an event (e.g., an inspection and/or maintenance event, a warning event, a trip event, a failure event, or other suitable event). For example, the hardware management system 10 may receive a part number for a particular mechanical system component (e.g., a combustor of a gas turbine system) receiving maintenance or a regularly scheduled inspection. In certain embodiments, a user may provide this part identifier to the system 10 via the input device 18, while in other embodiments the user may provide this part identifier via a remote system 22 to be received by the network interface 24. Furthermore, in certain embodiments, a user may enter the part identifier into a user input mechanism, such as a text box (e.g., using a keyboard). In other embodiments, a user may navigate a list of parts (e.g., an electronic parts catalog) to select a particular part identifier to supply to the hardware management system 10 (e.g. using a mouse or similar input device 18).

Continuing through the process 30 illustrated in FIG. 3, once the hardware management system 10 has received the part identifier, the hardware management system 10 may request and receive (block 34) information from the database system 20 about the part and other substantially similar parts. That is, once the hardware management system 10 knows which part a user wishes to access, the system 10 may use the received part identifier to extract relevant information from one or more data sources (e.g., database system 20 and/or databases stored on one or more remote systems 22) storing event data (e.g., inspection and maintenance data) for various mechanical systems in the fleet. In certain embodiments, the information requested and received by the hardware management system 10 may be presented to the user in the form of a table similar to the embodiment of FIG. 4.

FIG. 4 illustrates an embodiment of a table 50 of related part information which may be presented to the user after a part identifier has been received by the hardware management system 10. In the illustrated table 50, each row 52 corresponds to a specific part implemented in a mechanical system somewhere in the fleet. Additionally, all of the rows 52 correspond to parts that are substantially similar (e.g., parts that serve similar roles and/or have similar functions) that may be implemented in similar or different mechanical systems in the fleet (e.g., at different locations). Furthermore, the table 50 includes a number of columns that may include certain details (e.g., part identifiers, location, configuration, etc.) retrieved from the database system 20 regarding each of the parts. For example, the illustrated table 50 includes a number of part identifiers 54, part location information 56, part details 58, and part configuration information 60. Additionally, in certain embodiments, the user may subsequently select a particular part (e.g., a particular row 52) from the table 50 before proceeding.

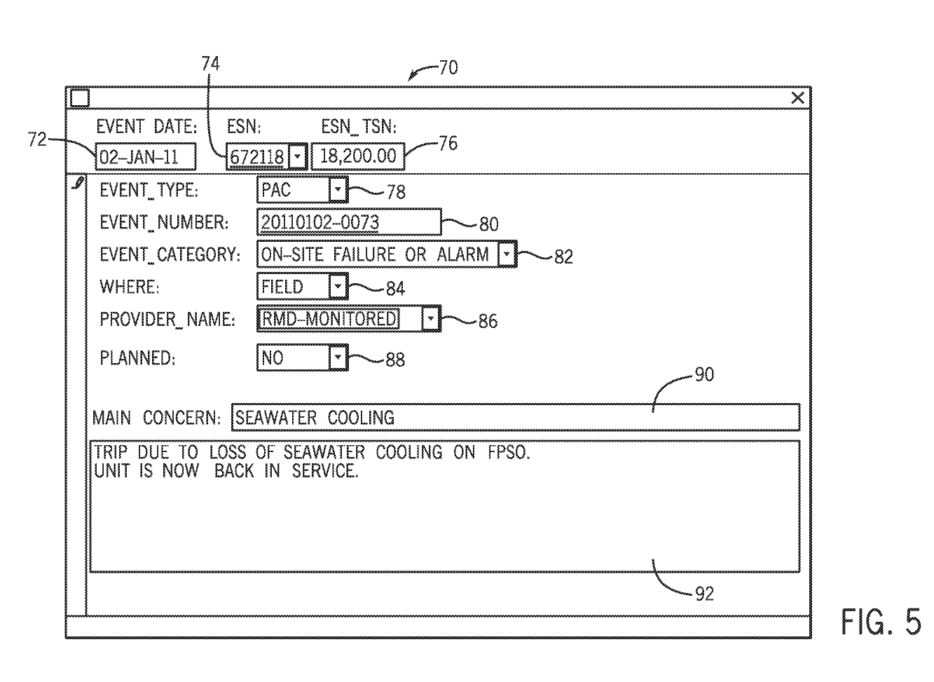

Returning to FIG. 3, the hardware management system 10 may receive and store (block 36) one or more details for the event being experienced by the part. That is, whether the event is a problem with the part (e.g., a trip, warning, fault, or failure), maintenance of the part, or an inspection of the part, the hardware management system 10 may receive information relating to the event (e.g., via input device 18 and/or network interface 24). For example, FIG. 5 illustrates an embodiment of a screenshot of a user interface 70 of the data collection module 27 of the hardware management system 10, whereby a user may provide event details to the hardware management system 10. That is, the illustrated user interface 70 may be a user interface executed by the hardware management system 10, or by a remote system 22 interfacing with system 10 via network interface 24, to enable a user to provide of event details to the system 10.

The embodiment of the user interface 70 illustrated in FIG. 5 includes an event date field 72, a part identification number 74, a number of hours 76 the part has been in service at the time the event, an event type 78, an event identifier 80, an event category 82, an event location 84, a service provider 86, planned/unplanned status 88, a main concern field 90, and an additional description field 92. It should be appreciated that the fields illustrated in the user interface 70 are intended to be examples and, therefore, in other embodiments, additional, fewer, or alternative fields may be used to provide event details for the component to the system 10. Additionally, in certain embodiments, the user interface 70 and/or data collection module 27 may be equipped with an import tool which may be used to select electronic copies of reporting documents (e.g., maintenance and/or inspection reports) such that event details may be automatically gleaned from such reports and provided to the hardware management system 10.

Returning again to FIG. 3, the hardware management system 10 may receive and store (block 38) one or more pictures or images corresponding to the part event. That is, in addition to the event details received with respect to block 36, the hardware management system 10 may receive (e.g., via input device 18 and/or network interface 24) and store (e.g., in database system 20) one or more images acquired from the event. For example, for a maintenance event, the one or more images received by the hardware management system 10 may be images (e.g., acquired using a digital camera) that illustrate specific portions of the failed and/or replacement part. Similarly, for an inspection event, the one or more images received by the system 10 may illustrate dimensions of specific portions of the part that may be used to determine the condition (e.g., the wear and/or damage) of the part. It should be appreciated that, for certain events (e.g., trip or warning events), the data collection module may not receive and store pictures or images for the event.

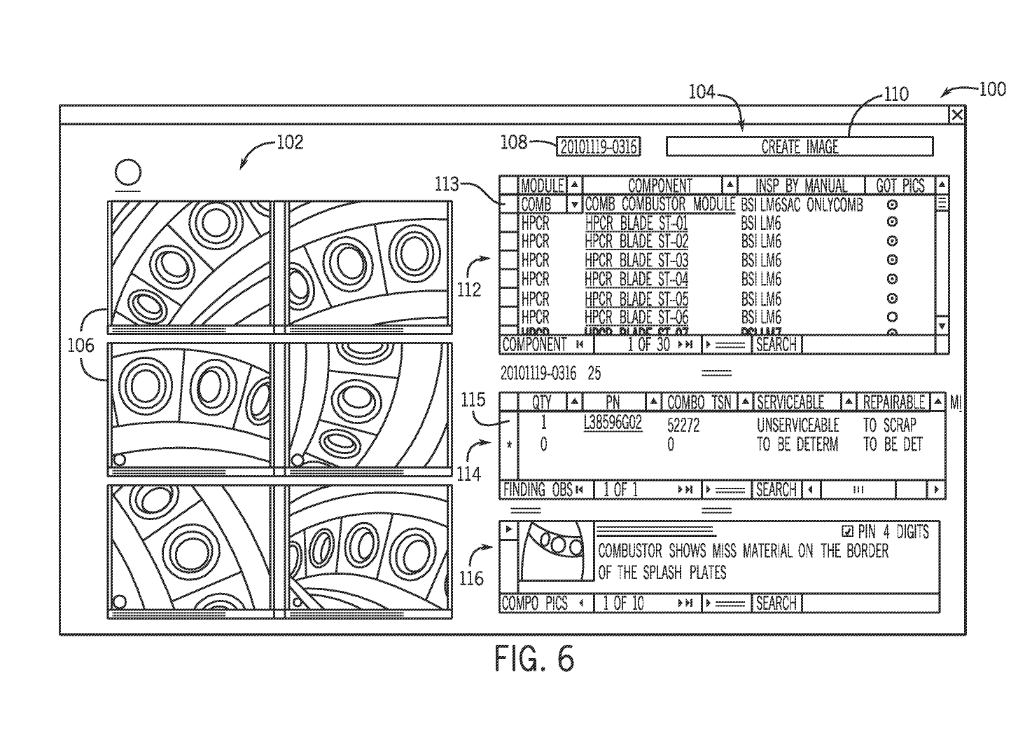

FIG. 6 illustrates an example of a user interface 100 that a user may utilize to provide the one or more event images to the hardware management system 10. That is, the illustrated user interface 100 may be a user interface of the data collection module 27 executed by the hardware management system 10, or by a remote system 22 interfacing with system 10 via network interface 24, to enable a user to provide the event images to the system 10. The illustrated user interface 100 includes an image display portion 102 and an image details portion 104. The text box 108 may allow the user to identify a particular image (e.g., stored on a digital camera input device 18, NV storage 16, or a memory of a remote system 22) to be associated with a particular event when the “Create Image” button 110 is selected. Additionally, in certain embodiments, the text box 108 may, additionally or alternatively, include an interface (e.g., a pop-up file explorer window) to allow a user to browse one or more file systems to select a particular image file to associate with the event. The image display portion 102 of the user interface 100 may generally display all of the images 106 that have been provided to the system 10 to be associated with the event. Additionally, in certain embodiments, the user interface 100 may be equipped with an import tool which may be used to select electronic copies of reporting documents (e.g., maintenance and/or inspection reports) such that event images may be automatically gleaned from such reports and provided to the system 10.

Additionally, the image details portion 104 of the user interface 100 includes tables 112, 114, and 116 that generally include information to organize and provide details for the images 106. For example, table 112 may include a list of parts relevant to the event. In certain embodiments, the table 112 may include a number of fields storing information (e.g., module name, component name, whether or not images have been stored for the part, or similar information) regarding a particular part. Accordingly, each part listed in table 112 may have one or more images associated with it. For example, when a particular part is selected from table 112, each row in table 114 may represent a summary observation for the selected component, and each row (or record) in the table 116 may represent an image associated with the selected component from table 112. For example, in the illustrated user interface 100, the first row 113 (e.g., the combustor module) of table 112 is selected and, accordingly, table 114 includes a single row 115 storing observations correlated to the part of selected row 113. In general, the table 114 may include any number of fields storing observations (e.g., part identifiers, whether the part was serviceable, whether the part was repairable, or similar information) pertaining to the selected part in table 112. In certain embodiments, the table 114 may be used to add additional observations pertaining to the selected part 113. Additionally, the illustrated table 116 includes a number of records (e.g., each record being an image) that are also associated with the selected part of row 113. Furthermore, each record in the illustrated table 116 additionally stores other information pertaining to a particular image. For example, in certain embodiments, the table 116 may store relevant file information (e.g., a file path, a file type, a file size, or similar file information) for the image file and/or image description text.

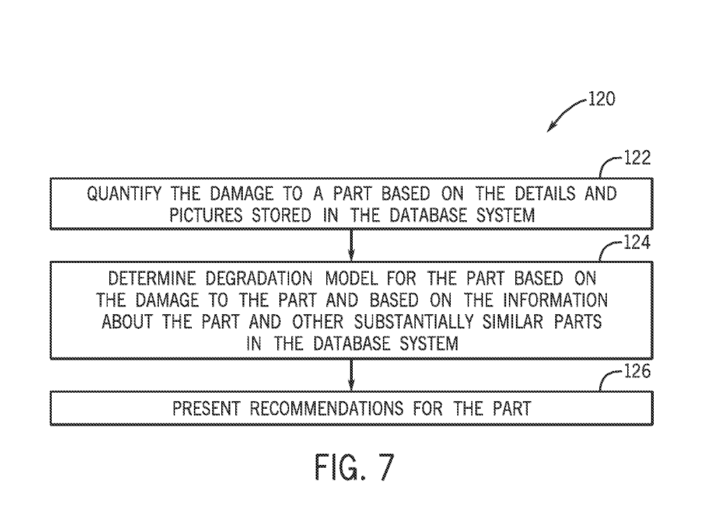

Once the hardware management system 10 has collected event data for one or more mechanical systems and/or parts of the fleet, other modules of the hardware management system 10 (e.g., the hardware condition module 28 and/or event reporting module 29) may subsequently utilize this event data. For example, turning to FIG. 7, an embodiment of a process 120 is illustrated for constructing a degradation model and determining maintenance recommendations for a mechanical system or component based on the collected event data. As illustrated in FIG. 7, after the hardware management system 10 has received the details and images for the event (e.g., using the process 30 of FIG. 3), the hardware management system 10 may quantify (block 122) the damage to the part based on the received details and/or images. In certain embodiments, the hardware condition module 28 of the hardware management system 10 may include a user interface (e.g., executed on the hardware management system 10 or on a remote system 22 coupled to system 10 via network interface 24) to facilitate image analysis. In other embodiments, the hardware management system 10 may analyze the received images without user interaction to determine damage to the part (e.g., using Bayesian networks, genetic algorithms, neural networks, or similar machine-learning techniques) once the hardware management system 10 has been trained by a user (e.g., via one or more user interfaces).

FIG. 8 illustrates an embodiment of a user interface 130 of the hardware condition module 28 that may receive annotations identifying specific dimensions and/or features within the images of the part event that may be used to quantify the wear and/or damage to the part. That is, the user interface 130 may be presented to a user (e.g., as a pop-up window), for example, when a new image is uploaded to the hardware management system 10 (e.g., using button 110 of user interface 100 of FIG. 5) or when a particular existing image is selected for annotation (e.g., by selecting a particular record of table 116). Generally speaking, the user interface 130 includes an image display portion 132 that may present the selected image 133 to the user for annotation. The user interface 130 further includes an image annotation portion 134 that may provide a number of options and/or tools to facilitate the annotation of the image 133. For example, illustrated user interface 130 includes an input box 136 and a “Load New Image” button 137 which may respectively function similar to the user input box 108 and the “Create Image” button 110 of user interface 100, allowing the user to change the file path of the image 133.

Additionally, the image annotation portion 134 of the user interface 130 illustrated in FIG. 8 further includes a tool 138 that may allow a user to indicate or identify a particular portion of the image 133 (e.g., the base of the part). Generally speaking, the tool 138 may allow the user to draw a particular shape (e.g., a line, a rectangle, a square, a circle, or other geometric figure) over the image 133. For example, using the tool 138 a user may draw a line 139 over a particular portion of the image 133 to visually identify the dimensions of the base of the part illustrated in the image 133. Furthermore, the illustrated image annotation portion 134 includes a tool 140 which enables the user to provide known dimensions to the shape drawn over the image 133 using the tool 138. That is, the tools 138 and 140 may generally work in conjunction to enable a user to instruct the hardware management system 10 how to appropriately interpret the scale of the features included in the image 133. By adding a shape of known dimensions (e.g., a line of known length), the relative scale of the features of the image 133 may be determined by the system 10. Additionally, the illustrated image annotation portion 134 includes another tool 142 to draw different shapes (e.g., lines, rectangles, squares, triangles, circles, or other geometric figure) over the image 133 to identify particular portions of the part shown in the image 133. For example, using the tool 142 a user may draw a rectangle 141 over the image 133 to mark a particular portion of the underlying image 133. Furthermore, the illustrated image annotation portion 134 also includes a tool 144 that may use the shapes defined using the tool 142 and the scale provided by the user using tools 138 and 140 to assign numerical values to various dimensions of the part illustrated in image 133. That is, based on the relative scale established using tools 138 and 140, the hardware management system 10 may determine a number of different dimensions (e.g., length, thickness, area, volume, or similar dimensions) of the part. Additionally, in certain embodiments, the image display portion 132 user interface 130 may include textual information 146 that may be used to inform the user of the dimensions of the image 133 determined using the tools 138, 140, 142, and 144. Also, the user interface 130 may include a user input 148 to allow the system 10 to receive these image annotations from the user for subsequent storage and/or analysis.

Turning once again to FIG. 7, once the hardware management system 10 has received details and annotated pictures for the part event, the system 10 may determine (block 124) a degradation model for the part. For example, based on the event details received in block 36 of FIG. 3, the pictures received in block 38 of FIG. 3, information from substantially similar parts collected in block 34 of FIG. 3, and/or the image annotation information received in block 120 of FIG. 7, the hardware management system 10 may construct models that may track the progression of wear and/or damage to the various portions of the part over time. Furthermore, in addition to tracking degradation trends within the part, the models constructed by the hardware management system 10 may predict future wear and/or damage to the part, incorporate statistical information from similar parts within the fleet, predict when the part is likely fail, and makes recommendations of when to perform maintenance on (e.g., replace) the part. In certain embodiments, the hardware management system 10 may construct one or more graphs using the degradation model, in which the graphs may serve as a visual representation of the degradation of the part and/or predictions for when the part is likely to fail (e.g., reach an unserviceable condition).

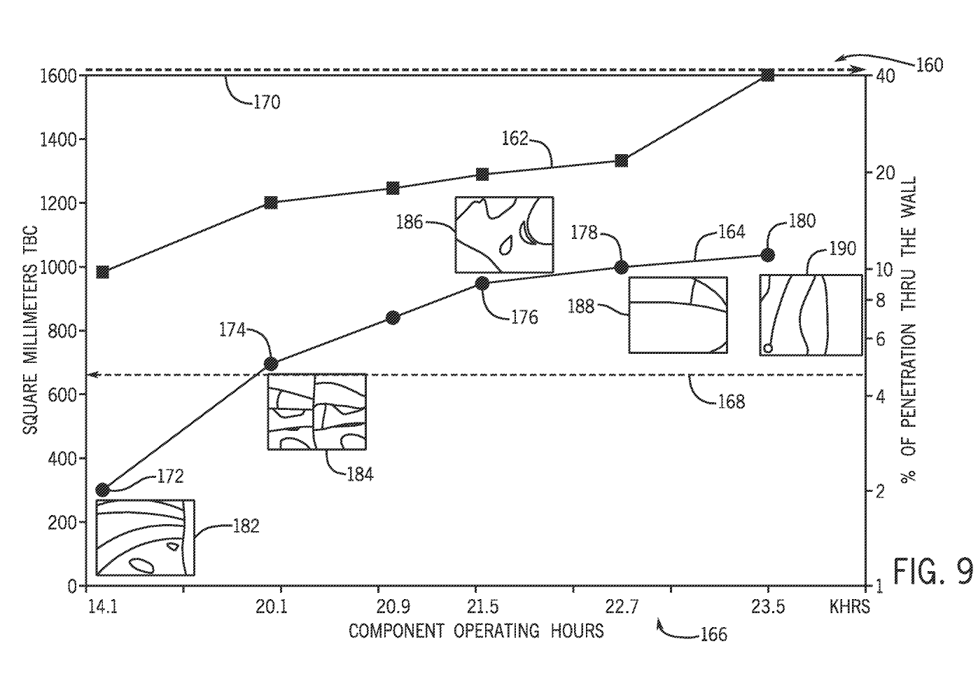

For example, FIG. 9 is an interactive graph 160 illustrating multiple degradation trends (i.e., multiple potential modes of failure) of a particular part (e.g., a combustor) such as may be generated by the hardware condition module 28 of the hardware management system 10. In particular, the graph 160 plots two different part degradation trends (i.e., square millimeters lost from the combustor heatshield wing 162 and percent penetration through the combustor wall 164) against the combustor operating hours 166. Furthermore, graph 160 illustrates horizontal lines representing limits (i.e., the maximum limit for heatshield wing loss 168 and the maximum limit for percent penetration through the combustor wall 170) for each of these modes of failure for the part. In certain embodiments, these limits may be based on company policy, standards set forth by governmental regulation, and/or recommendations of the component manufacturer. Additionally, graph 160 may generally be interactive in that a user may be able to select specific data points (e.g., using a mouse or other similar input device 18), and additional information stored by the hardware management system 10 for that data point may be displayed to the user and or added to the graph 160. For example, in the illustrated graph 160 a user has selected (e.g., via a mouse click or similar operation) data points 172, 174, 176, 178, and 180 of the degradation trend line 164 and, accordingly, images corresponding to each of these data points (i.e., images 182, 184, 186, 188, and 190, respectively) have been added to the graph 160. In other embodiments, other event information (e.g., event descriptions, whether or not the event was planned, the service provider, or other similar information) may be added to the graph 160 in a similar fashion. It should be appreciated that this interactivity generally enables a user to more efficiently manage and navigate the large quantity of maintenance and inspection data that may accumulate for a particular component over its lifetime.

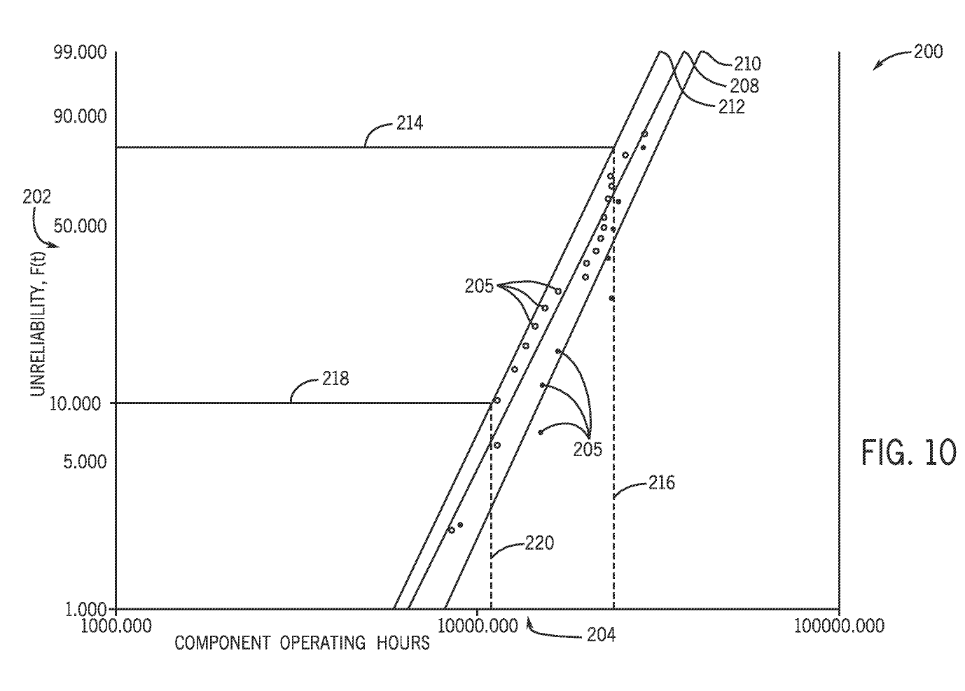

Additionally, the hardware condition module 28 of the hardware management system 10 may use the degradation trends illustrated and graph 160, along with statistical data from other substantially similar components in the fleet, to construct a degradation model to predict when the part is likely to fail (e.g., reach an unserviceable condition). For example, FIG. 10 is a graph 200 illustrating an embodiment of a degradation model for a particular component (e.g., the combustor described with respect to FIG. 9) that incorporates the degradation trend data from the component, as well as other similar components within a fleet. The illustrated graph 200 generally plots estimated component unreliability 202 against operational hours of the component 204. Each point in the illustrated graph 200 either represents an inspection event for the heatshield wing of the combustor (i.e., points 205) or an inspection event for the combustor wall (i.e., points 206) for the combustor being modeled. Furthermore, in certain embodiments, the points 205 and 206 may be additionally color-coded to provide additional information to the user regarding each part event (e.g., colors to indicate the portion of the part being inspected, colors to indicate the number of inspection points or images acquired for the event, and/or colors to indicate whether the condition of the part at the time of assessment is average or better or worse relative to other similar parts in the fleet). Additionally, the illustrated graph 200 includes lines 208 and 210, which may track the general trends illustrated by the collections of points 205 and 206, respectively. That is, lines 208 and 210 may represent best fit lines for the data points 205 and 206, respectively. For example, the line 208 may track the degradation of the heatshield wing of the combustor while the line 210 may track the degradation of the combustor wall.

Furthermore, the illustrated graph 200 includes a line 212 that illustrates a total estimated unreliability of the component (e.g., the combustor) over the operational hours of the component. That is, the line 212 may include considerations of multiple potential modes of failure for the component based, at least in part, on the inspection and maintenance data for the component. For example, in the illustrated graph 200, the line 212 may be determined based, at least in part, on the trends (e.g., lines 208 and 210) for the different modes of failure for the combustor (e.g., via heatshield wing failure or combustor wall failure). Furthermore, the line 212 may additionally incorporate statistical data from similar components in service elsewhere in the fleet. In other words, the total estimated unreliability of the component may be based, at least in part, on a number of determined degradation trends (e.g., lines 208 and 210) for the component as well as information regarding when and how similar components elsewhere in the fleet failed. For example, the total estimated unreliability of the component (e.g., line 212) may weight particular modes of component failure over others based on how similar components within the fleet failed.

Turning once more to FIG. 7, once the degradation model for the part has been determined, the hardware condition module 28 of the hardware management system 10 may present (block 126) recommendations for the part. For example, the hardware condition module 28 may recommend that a particular component be repaired, replaced, or inspected at a particular time. By further example, the hardware management system 10 may recommend that the component be used differently (e.g., operated at less than maximum capacity) for a period of time to avoid system failure. For example, turning once more to FIG. 10, the hardware management system 10 may be configured to make recommendations for the part based on the constructed degradation model (e.g., illustrated in graph 200) and one or more limits In certain embodiments, these limits may be defined by the manufacturer of the component, company policy, or governmental or similar regulatory policy. For example, in FIG. 10 the horizontal line 214 (i.e., defined by approximately 85% unreliability of the component) is based on a particular company policy which recommends component replacement at or above approximately 85% unreliability. Accordingly, based on the line 212, 85% unreliability of the component (i.e., horizontal line 214) approximately corresponds to the vertical line 216 (i.e., approximately 25,000 hours of operation). As such, based on the particular company policy, the hardware management system 10 may generally recommend that the component be replaced at approximately 25,000 hours of operation in order to minimize the possibility that the component may fail. Furthermore, the hardware management system 10 may generally recommend that component be inspected at regular intervals beyond a particular unreliability level. For example, in the illustrated graph 200, the horizontal line 218 (i.e., defined by approximately 10% unreliability of the component) is also based on a particular company policy which recommends monthly inspections for a component having an unreliability greater than 10%. Accordingly, using the line 212 that estimates the unreliability of the component, 10% unreliability of the component (i.e., horizontal lines 218) approximately course bonds to the vertical line 220 (i.e., approximately 12,000 hours of operation). As such, based on the particular company policy, the system 10 may generally recommend that the component be inspected monthly beyond approximately 1200 hours of operation in order to minimize the possibility that the component may fail. Additionally, in certain embodiments, the recommendations made by the system 10 may be reviewed by one or more experts to ensure that these maintenance recommendations are sound and in-line with the various policies of the company.

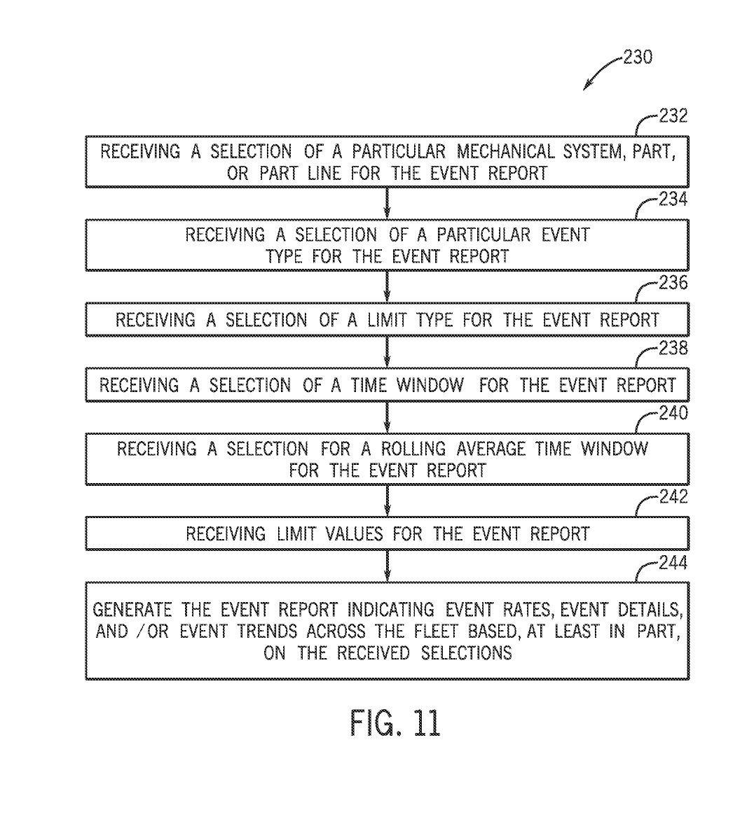

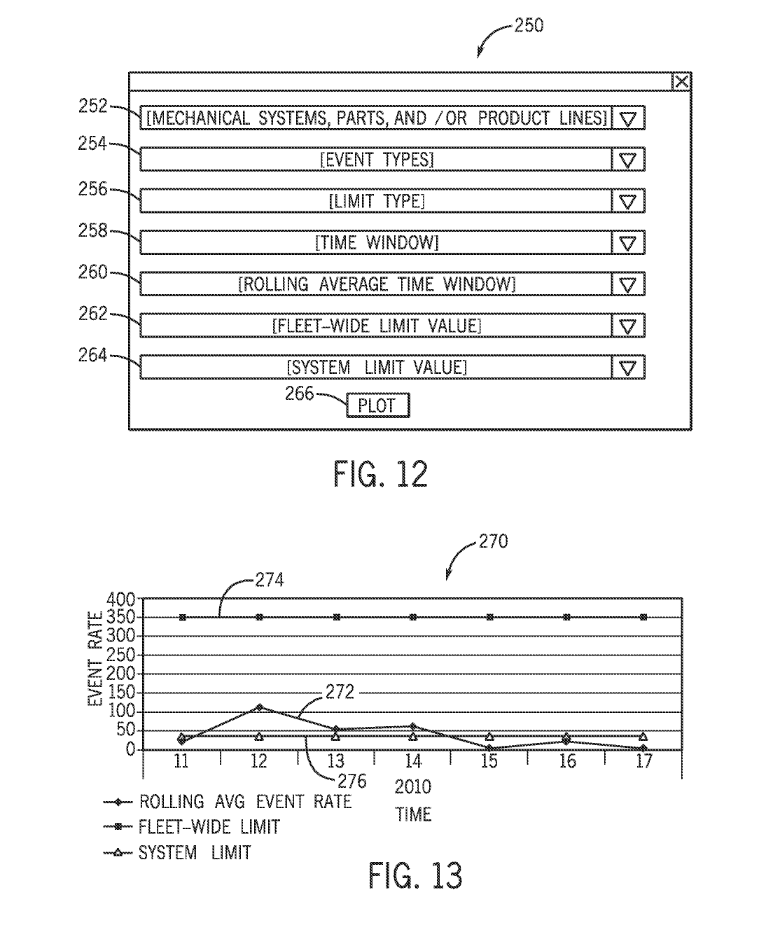

As mentioned above, once the hardware management system 10 has collected event data for one or more mechanical systems and/or parts of the fleet (e.g., as in FIG. 3), the event reporting module 29 may also subsequently utilize this event data to generate event reports. Further, as set forth below, the generated event reports may include, for example, event rates, event details, and/or event trends across the fleet. For example, turning to FIG. 11, an embodiment of a process 230 is illustrated for generating event reports based, at least in part, on the event data collected by the data collection module 27. In particular, FIG. 11 illustrates the process 230 being performed using an embodiment of a user interface 250 illustrated in FIG. 12. Furthermore, it should be appreciated that the steps illustrated in the process 230 may, in certain embodiments, be executed in other orders and/or portions of the process 230 may be skipped entirely. Furthermore, in other embodiments, the user interface 250 may include other options for the generated event report (e.g., sort order for the event report, grouping by mechanical system or component for the event report, and so forth) in addition to those illustrated in FIG. 12.

The illustrated process 230 begins with the user interface 250 of the event reporting module 29 of the hardware management system 10 receiving (block 232) a selection for a particular mechanical system, part, or product line for the event report. As such, in certain embodiments, a user may utilize the user input 252 (e.g., select box 252) of FIG.12 to select a particular mechanical system, part, or product line from a list of mechanical systems, parts, and or product lines present within the fleet. In certain embodiments, the user may be capable of selecting one, two, three, or any number of mechanical systems, parts, and/or product lines using the user input 252.

The next step in the process 230 illustrated in FIG. 11 involves the user interface 250 of the event reporting module 29 of the hardware management system 10 receiving (block 234) a selection of a particular event type for the event report. For example, in certain embodiments, a user may utilize the user input 254 (e.g., select box 254) of FIG. 12 to provide a selection for a particular event type to the user interface 250. By specific example, in certain embodiments, the event type may include hardware trips, warnings, alerts, alarms, inspection, maintenance, replacement, or other suitable events.

Continuing through the process 230 illustrated in FIG. 11, next, the user interface 250 of the event reporting module 29 of the hardware management system 10 may receive (block 236) a selection of a particular limit type for the event report. For example, in certain embodiments, a user may utilize the user input 256 (e.g., select box 256) of FIG. 12 to provide a selection for a particular limit type when generating the event report. For example, in certain embodiments, the user input 256 of FIG. 12 may allow the user to limit the event report to the entire fleet, sub-portions of the fleet (e.g., by particular locations), and/or to mechanical systems or parts experiencing the highest event rates (e.g., top 5 systems, top 10 systems, and so forth). Further, in certain embodiments, the user input 256 may be used by the user to provide an indication that the user desires to limit the event report to systems included in a “Custom List.” In such embodiments, when the user selects the “Custom List” option using the user input 256, the user may be presented with one or more subsequent user interfaces (e.g., pop-up boxes or similar interfaces) that may allow the user to provide (e.g., select and/or enter) mechanical systems and/or parts that should be included on the event report.

Next in the process 230 illustrated in FIG. 11, the user interface 250 of the event reporting module 29 of the hardware management system 10 may receive (block 238) a selection of a particular time window for the event report. For example, in certain embodiments, a user may utilize the user input 258 (e.g., select box 258) of FIG. 12 to provide a selection for a particular time window when generating the event report. In certain embodiments, the select box 258 may include a number of numeric values representing a period of time (e.g., in days, weeks, months, quarters, years, or other suitable period of time). By specific example, in certain embodiments, the select box 258 may include a range of values (e.g., between 1 and 52) representing a time period, for example, in weeks from the present, that the event report should include. In other embodiments, the user interface 250 may include multiple user inputs (e.g., a start date user input and an end date user input, or other suitable user inputs) that the user may utilize to provide the desired time window for the event report to the event reporting module 29 of the hardware management system 10.

As mentioned, the event reporting module 29 may determine one or more rolling average values (e.g., a rolling average event rate) based on the event data stored in the database system 20 when generating event reports. As such, continuing through the process 230 illustrated in FIG. 11, the user interface 250 of the event reporting module 29 of the hardware management system 10 may also receive (block 240) a selection of a rolling average time window for the event report. For example, in certain embodiments, a user may utilize the user input 260 (e.g., select box 260) to provide a selection of a particular time window for computing rolling averages. In certain embodiments, the select box 260 may include a number of numeric values representing a period of time (e.g., in days, weeks, months, quarters, years, or other suitable period of time). By specific example, in certain embodiments, the select box 260 may include a range of values (e.g., between 1 and 52) representing a time period, in weeks, that may be used when determining rolling average values (e.g., a rolling average event rate).

The next step of the process 230 illustrated in FIG. 13 involves the event reporting module 29 of the hardware management system 10 receiving (block 242) one or more limit values for the event report. For example, in certain embodiments, user interface 250 (as illustrated in FIG. 12) includes user inputs 262 and 264 to enable the user to provide one or more limit values (e.g., a fleet-wide limit value 262, a particular system limit value 264, or other suitable limit values) that may be included (e.g., plotted) on the generated event report for comparison. By specific example, in certain embodiments, the user inputs 262 and 264 may enable the user to provide two numerical values (e.g., integers or real numbers) that may represent a threshold value for events, based on the recommended practices of the manufacturer, company policy, industry and/or regulatory compliance, and/or similar considerations. In other embodiments, a fleet-wide limit value, a particular system limit value, or other suitable limit values may be derived from the event data stored in the database system 20.

The final step in the process 230 illustrated in FIG. 11 involves the event reporting module 29 of the hardware management system 10 generating (block 244) the event report based, at least in part, on the received selections (e.g., from blocks 232-242). For example, in an embodiment, once the user has used one or more of the user inputs 252, 254, 256, 258, 260, 262, and/or 264 illustrated in FIG. 12 to provide the selections set forth above, the user may select the user input 266 (e.g., button 266) of FIG. 12 to inform the event reporting module 29 that the user is ready for the event reporting module 29 to generate the event report. Once the event reporting module 29 determine that the user has selected the user input 266, the event reporting module 29 may generate an event report based, at least in part, on the selections of the user.

For example, FIG. 13 illustrates an embodiment of an event report 270 such as may be generated by the event reporting module 29 of the hardware management system 10 based, at least in part, on the selections of the user (e.g., in the process 230 of FIG. 11) and on the event data in the database system 20 (e.g., collected by the process 30). Additionally, the illustrated event report 270 includes a graph portion having three lines: a rolling average event rate 272, a fleet-wide limit 274, and a system limit 276. For example, for the event report 270 illustrated in FIG. 13, the rolling average event rate 276 may represent the rolling average event rate for a combustor of a gas turbine system over specific weeks (e.g., weeks 11-17) of a particular year (e.g., 2010). Accordingly, a user viewing the event report 270 may visually determine that during a few weeks of the illustrated time period (e.g., weeks 11, 15, 16, and 17) the rolling average event rate 272 was below the system limit 276, while during other weeks of the illustrated time period (e.g., weeks 12, 13, and 14), the rolling average event rate for the combustor was greater than the system limit Furthermore, based on the event report 270, the user may determine that the rolling average event rate 272 for the combustor remained substantially below the fleet-wide limit value. Additionally, in certain embodiments, the user may interact with the event report 270 (e.g., selecting particular data points along the line 272) and the event report 270 may provide additional information regarding the selected data point (e.g., event details).

Technical effects of the present embodiments include the ability to efficiently maintain a fleet the mechanical systems in order to maximize uptime of mechanical systems, minimize the risk and cost of associated with failure of the mechanical systems, and minimize maintenance costs associated with the mechanical systems. That is, present embodiments enable the construction of degradation models for inspected components that are based on event data (e.g., inspection and maintenance data) accumulated from the entire fleet of mechanical systems. In addition to collecting and managing event data, present embodiments enable a user to visually annotate inspection images to facilitate the construction of the degradation models. By efficiently organizing inspection and maintenance data fleet-wide and utilizing this data when constructing and interpreting the degradation models, the presently disclosed system may generally provide maintenance recommendations for the mechanical systems without requiring expert input. Furthermore, present embodiments enable these maintenance and/or inspection recommendations to be made based, at least in part, on the constructed degradation models as well as company and/or regulatory policies.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
an interface configured to receive one or more images from an inspection of a component of a mechanical system, wherein each of the one or more images include corresponding annotations that at least define one or more dimensions of the component;
a processor configured to:
construct a degradation model for the component based, at least in part, on the one or more images and their corresponding annotations received by the interface; and
determine one or more maintenance recommendations for the component based, at least in part, on the degradation model constructed for the component.

2. The system of claim 1, wherein the interface comprises one or more local input devices or a network interface coupled to a remote system.

3. The system of claim 1, wherein the degradation model generates one or more graphs comprising an estimated component degradation rate, an estimated unreliability of the component, or any combination thereof.

4. The system of claim 3, wherein the one or more graphs comprise the one or more images from the inspection of the component, annotations corresponding to the one or more images, or any combination thereof.

5. The system of claim 1, wherein the one or more maintenance recommendations comprise recommending replacing the component, recommending repairing the component, recommending inspecting the component at a specified time, or any combination thereof.

6. A method, comprising:
receiving and storing in a memory of an electronic device one or more event details for a part event, wherein the part event comprises an inspection or maintenance of a part of a mechanical system;
receiving and storing in the memory of the electronic device one or more event images of the part event;
constructing, via a processor of the electronic device, a degradation model for the part based, at least in part, on the one or more event details and the one or more event images; and
determining, via the processor of the electronic device, maintenance recommendations for the part based, at least in part, on the degradation model for the part.

7. The method of claim 6, comprising receiving and storing in the memory of the electronic device a part identifier for the part experiencing the part event.

8. The method of claim 7, comprising determining, via the processor of the electronic device, information for other parts substantially similar to the part of the mechanical system based, at least in part, on the received part identifier, and wherein the degradation model is based, at least in part, on the information for the other parts substantially similar to the part.

9. The method of claim 6, comprising providing a user interface to receive the one or more event details and the one or more event images, wherein the user interface to receive the one or more event details comprises a plurality of instructions executed by the processor of the electronic device.

10. The method of claim 6, comprising quantifying damage to the part based, at least in part, on the one or more images of the part event, wherein quantifying damage to the part comprises receiving and storing one or more annotations for the one or more event images, wherein the one or more annotations define dimensions of features of the part in the one or more images.

11. The method of claim 10, comprising providing a user interface to receive the one or more annotations for the one or more event images, wherein the user interface to receive the one or more annotations comprises a plurality of instructions executed by the processor of the electronic device.

12. The method of claim 6, wherein the degradation model is based, at least in part, on previous event details and previous event images from one or more previous part events.

13. The method of claim 6, wherein the degradation model comprises multiple modes of failure for the part.

14. The method of claim 6, wherein the degradation model is constructed based on a Weibull distribution.

15. The method of claim 6, wherein the maintenance recommendations for the part are based, at least in part, on the degradation model and one or more limits operational limits of the part.

16. One or more tangible, non-transitory, computer-readable media storing instructions executable by a processor of an electronic device, the instructions comprising:
instructions to receive a part identifier for a part of a mechanical system;
instructions to determine information for the part and other substantially similar parts based on the received part identifier;
instructions to receive one or more annotated inspection images for the part, wherein one or more annotated inspection images indicate one or more dimensions of the part;
instructions to construct a degradation model for the part based, at least in part, on the one or more annotated inspection images and the information for the part and other substantially similar parts; and
instructions to provide maintenance recommendations for the part based, at least in part, on the degradation model for the part and defined operational limits of the part.

17. The media of claim 16, wherein the instructions comprise instructions to receive one or more inspection details for the part.

18. The media of claim 16, wherein the instructions comprise instructions to present a user interface for annotating and receiving the one or more annotated inspection images for the part.

19. The media of claim 16, wherein the operational limits of the part are defined by a manufacturer of the part, an owner of the part, a maintainer of the part, or any combination thereof.

20. The media of claim 16, wherein the instructions to determine information for the part and other substantially similar parts comprise instructions to retrieve previous annotated inspection images for the part and annotated inspection images for substantially similar parts, and wherein the degradation model is based, at least in part, on the previous annotated inspection images for the part and the annotated inspection images for substantially similar parts.

21. A system, comprising:
a memory and a processor configured to:
provide an event details user interface, wherein the event details user interface is configured to collect event details for a mechanical system or a mechanical part;
store the collected event details for the mechanical system or the mechanical part in a database system; and
generate an event report for the mechanical system or mechanical part based, at least in part, on the event details stored in the database system.

22. The system of claim 21, wherein the event details comprise a serial number, an event type, an event location, an event description, hours of operation, downtime, or any combination thereof, for the mechanical system or mechanical part.

23. The system of claim 21, wherein the event details user interface is configured to collect the event details for the mechanical system or mechanical part by gleaning information relating to the mechanical system or mechanical part from inspection reports, maintenance reports, or both.

24. The system of claim 21, wherein the database system is configured to validate the event details for the mechanical system or mechanical part based, at least in part, on event details of other mechanical systems or mechanical parts stored in the database system, expert validation, or a combination thereof.

25. The system of claim 21, wherein the event report comprises a rolling average event rate for the mechanical system or mechanical part.

26. The system of claim 25, wherein the event report comprises one or more charts or graphs illustrating the rolling average event rate for the mechanical system or mechanical part.

27. The system of claim 21, wherein the processor is configured to provide an event report user interface, wherein the event report user interface is configured to receive one or more parameters for generating the event report for the mechanical system or mechanical part.

28. The system of claim 27, wherein the one or more parameters comprise an event type, a limit type, a time window, a rolling average event rate time window, a fleet-wide limit value, a system limit value, or any combination thereof.

29. The system of claim 21, wherein the event details user interface is configured to collect event details for a fleet of mechanical systems, mechanical parts, or both.

30. The system of claim 29, wherein the database system is configured to store the collected event details for the fleet of mechanical systems, mechanical parts, or both.

31. The system of claim 30, wherein the processor is configured to determine event trends for the fleet of mechanical systems, mechanical parts, or both, based on the event details for the fleet of mechanical systems, mechanical parts, or both.

32. The system of claim 31, wherein the event report comprises the determined event trends for the fleet of mechanical systems, mechanical parts, or both.

33. The system of claim 32, wherein the event report comprises one or more charts or graphs illustrating the determined event trends for the fleet of mechanical systems, mechanical parts, or both.

34. The system of claim 21, wherein the each of the event details are associated with a warning event, a trip event, a failure event, or a planned or unplanned inspection event experienced by the mechanical system or the mechanical part.

35. A method, comprising:
receiving, via a processor of an electronic device, event details for events experienced by a plurality of parts disposed throughout a fleet of mechanical systems;
storing in a database system the received event details for the events experienced by the plurality of parts, wherein the database system is disposed in a memory of the electronic device;
receiving, at the processor of the electronic device, an indication of a selection of a particular part from the plurality of parts disposed throughout the fleet of mechanical systems; and
generating, via the processor of the electronic device, an event report for the particular part based on the event details stored in the database system, wherein the event report comprises an event rate for the particular part.

36. The method of claim 35, wherein the event details comprise a serial number, an event type, an event location, an event description, and hours of operation for each of the events experienced by a plurality of parts.

37. The method of claim 35, comprising receiving, at the processor of the electronic device, a selection of a rolling average time window for use in generating the event report for the particular part.

38. The method of claim 37, wherein the event rate comprises a rolling average event rate that is determined, via the processor of the electronic device, for the particular part over the received rolling average time window.

39. The method of claim 38, wherein the event report comprises a fleet-wide average event rate, a mechanical system event rate limit, a fleet event rate limit, or a combination thereof, based, at least in part, on the event details stored in the database system.

40. The method of claim 39, wherein the mechanical system event rate limit, fleet event rate limit, or both, are based on company or regulatory policy.

41. The method of claim 35, wherein the events comprise warning events, trip events, failure events, or inspection events experienced by the plurality of parts.

42. One or more tangible, non-transitory, computer-readable media storing instructions executable by a processor of an electronic device, the instructions comprising:
instructions to store, in a database system of the electronic device, event details for events experienced by a fleet of mechanical systems;
instructions to receive a selection of a rolling average time window and to receive a selection of a particular mechanical system from the fleet of mechanical systems;
instructions to use the event details stored in the database system, the selection of the particular mechanical system, and the selection of the rolling average time window to determine a rolling average event rate for the particular mechanical system over time; and
instructions to generate an event report for the particular mechanical system, wherein the event report comprises a plot of the rolling average event rate for the particular mechanical system over time.

43. The media of claim 42, wherein the instructions comprise instructions to receive event details for events experienced by the fleet of mechanical systems, and wherein the event details comprise serial numbers, event types, event locations, event descriptions, hours of operation, downtime, or any combination thereof, for the fleet of mechanical systems.

44. The media of claim 43, wherein the instructions comprise instructions to receive one or more inspection reports, maintenance reports, or both, and to glean the event details from the one or more inspection reports, maintenance reports, or both.
